(19) United States
(12) Patent Application Publication
(10) Pub. No.: US 2023/0281238 A1
(43) Pub. Date: Sep. 7, 2023

(54) FACIAL TEST DATABASE MANAGEMENT SYSTEM FOR DETECTION OF FACIAL RECOGNITION DEVICE, AND METHOD

(71) Applicant: The Third Research Institute of Ministry of Public Security, Shanghai (CN)

(72) Inventors: Fangyi Xie, Shanghai (CN); Caixia Liu, Shanghai (CN)

(21) Appl. No.: 18/014,040

(22) PCT Filed: Jan. 28, 2021
(86) PCT No.: PCT/CN2021/074023

§ 371 Date: Mar. 2, 2023

(30) Foreign Application Priority Data
Jun. 30, 2020 (CN) 202010620982.X

(51) Int. Cl. G06F 16/51; G06T 7/00; G06V 20/70

(52) U.S. Cl. CPC G06F 16/51; G06T 7/0002; G06V 20/70; G06T 2207/30168; G06T 2207/30201

(57) ABSTRACT

A facial test database management system and method for testing a facial recognition device. The system includes a database archiving management module, an evaluation annotation functional module, and a testing service functional module. The database archiving management module is configured to perform hierarchical classification management based on user permission allocation and according to data set annotation information and a data set identifier coding rule. The evaluation annotation functional module is configured to perform data preprocessing and image annotation by a facial testing algorithm and image processing, and set a unique facial image code or a facial video code according to the data set identifier coding rule, to construct a large-scale normalized facial test database. The testing service functional module is configured to effectively provide, for performance testing of a facial recognition product according to a data set configuration rule, a test database that meets a relevant standard requirement, and provide a test result feedback statistics service after a test is finished. The security of facial image data for testing and the traceability of test information can be effectively guaranteed. Test database management support can be provided for the inspection and testing of various facial recognition products.

### TECHNICAL FIELD

The invention relates to a technology of managing a facial test database, and specifically to a technology of constructing and managing a facial image test database used for facial recognition performance indicator testing and a test training database supporting research and development of a facial recognition algorithm.

### BACKGROUND

As the most commonly used mode in the field of biometric recognition, facial recognition technology has been widely used in finance, justice, military, public security, border inspection, government, aerospace, electric power, factories, education, medical care and numerous enterprises and institutions in recent years.

The performance indicators False Acceptance Rate (FAR) and False Rejection Rate (FRR) are recognized as the key performance evaluation indicators of facial recognition in academia and business circles. The facial image database used in the evaluation has great influence on the testing results. The test databases used by different testing institutions to test facial recognition products lack uniform specification and management, which leads to the difference of evaluation results due to the difference of test databases.

Therefore, to evaluate the performance of facial recognition products scientifically and fairly, it is necessary to consider adding various factors that can qualitatively and quantitatively affect the performance to the database, such as the types of face photos, data sources, application scenarios, acquisition devices, lighting environment, posture, age span, gender, expression, skin color and so on.

To sum up, designing a facial test database management system for testing a facial recognition device, specifying a method of using same, and constructing a facial image test database integrating various factors can not only meet the increasing testing needs of facial recognition products, but also promote the technical progress of facial recognition products.

### SUMMARY

An objective of the invention is to design a facial test database management system for testing a facial recognition device, and accordingly provides a facial test database management method, to implement facial recognition performance indicator testing of products and support testing and training in the research and development of facial recognition algorithms.

To achieve the above objective, the invention provides a facial test database management system for testing a facial recognition device, including a database archiving management module, an evaluation annotation functional module, and a testing service functional module.

The database archiving management module is configured to run in a storage server, periodically update data of a facial test database based on a usage management requirement, and perform hierarchical classification management based on user permission allocation and according to data set annotation information and a data set identifier coding rule.

The evaluation annotation functional module is configured to run in a client, exchange data with database archiving management module, automatically evaluate facial images and facial videos imported in large batches, perform data preprocessing and image annotation by a facial testing algorithm and image processing, and set a unique facial image code or a facial video code according to the data set identifier coding rule, to construct a large-scale normalized facial test database.

The testing service functional module is configured to run in the client, call the database archiving management module, provide, for performance testing of a facial recognition product according to a data set configuration and usage rule, a test database that meets a standard requirement, and provide a test result feedback statistics service.

Further, the database archiving management module includes a primary storage database, a usage sub-database, an approval database, a preprocessing database and a feedback database.

The primary storage database includes individual data sets of single individuals, and a facial image and facial video in each individual data set in a constructed target facial test database each have a unique irreversible identification code.

The usage sub-database is a test database with a set scale and quantity obtained from the primary storage database according to a data set configuration rule and based on a performance test level requirement of a device to be tested, includes a target set and a probe set meeting a sample distribution requirement, and is configured to test performance indicators including a Fault Acceptance Rate (FAR) and a Fault Rejection Rate (FRR) of the device to be tested.

The approval database includes a database built by a data administrator and a database built by a test user, where an annotated data set in the built databases is verified according to an evaluation result from the evaluation annotation functional module, subjected to a conformity check performed based on a technical requirement on test databases in a standard, archived by the database archiving management module, and saved into the primary storage database after being approved by a user with highest rights.

The preprocessing database is configured to receive facial images or facial videos initially imported into the storage server in batches, perform data preprocessing in cooperation with the evaluation annotation functional module, provide an evaluation result, generate an annotated data set, and save the annotated data set into the approval database.

The feedback database includes individual data sets built by the test user, mainly coming from data sets for which a data anomaly occurs during performance testing performed by the testing service functional module using the downloaded usage sub-database, and is configured to update data in the primary storage database.

Further, the database archiving management module further includes a test result database, and the test result database is configured to store results of testing of the performance indicators including the FAR and the FRR for data update association and statistical analysis of test database service application requirements.

Further, the database archiving management module further includes data logs, and the data logs include logs related to operations and audit of all databases and test results in the database archiving management module for facial testing.

Further, the evaluation annotation functional module includes a data preprocessing module, a data set archiving module and a data set query module.

The data preprocessing module is configured to perform face cutting and image quality evaluation prompting on facial images acquired on site or imported in batches through corresponding image processing methods, and automatically transmitting the preprocessed data to the data set archiving module.

The data set archiving module is configured to annotate and generate codes for the preprocessed facial images according to an image identification and coding rule; and manage uniqueness of data set identifiers and facial image codes by using a corresponding data set identification rule and/or facial image coding rule according to different factors.

The data set query module is configured to query individual data sets in different test databases by using one or more screening conditions according to a rights requirement, provide a test database matching condition required for testing in an actual application scenario, and generate a statistical report according to the condition.

Further, the testing service functional module includes a database calling module, a device interface debugging module, a statistics and report module and a test result module.

The database calling module is configured to download or upload an individual data set according to a requirement and an operation.

The device interface debugging module is configured to interact with the device to be tested by calling a test interface function, to push or obtain a facial image.

The statistics and reports module is configured to provide data set statistics, project statistics, algorithm statistics and simulation test statistics.

The test result module is configured to manage test results of the performance indicators including the FAR and the FRR.

Further, the testing service functional module further includes a user login module, and the user login module is configured to cooperate with the database archiving management module to perform a rights-based access operation on each sub-database in the facial test database according to rights of a user.

To achieve the above objective, the invention provides a test database management method for testing a facial recognition device, including:

importing facial images in large batches, and automatically assigning unique face information codes to the facial images according to a data set identification and coding rule, to build a test database of a required category; and downloading a test database of a required scale according to a data set configuration and usage rule to form a target set and a probe set.

Further, the test database management method further includes: downloading a test database according to a data security mechanism during use, and implementing data encryption and desensitization with reference to a mapping relationship for use.

Further, the test database is a test sub-database formed according to the data set configuration and usage rule and based on a requirement of a single project test, is downloaded after authorization by a test administrator and stored in a ciphertext manner in a test server or test computer, and a data set information and code mapping table that simply sorts and numbers data after processing based on the mapping relationship can be viewed through a special decryption tool.

The test user views only desensitized information of data sets in the downloaded test database according to a condition after authorization by the data set query module of the management system, and by default, only browses images or plays videos. Sensitive information includes identifiers, codes, and annotation information of facial images or facial videos in data sets, sample distribution, etc.

A data set in the test database for which a data anomaly occurs during testing of the performance indicators including the FAR and the FRR is displayed in a form of a test result, only an image for which feature value extraction fails in the test result of the current test and a facial image or facial video in the test database are authorized through access and query of an automatic test system, and serial numbers of the image for which feature value extraction fails in the test result of the current test and the facial image or facial video in the test database are mapped to simple serial numbers obtained after local re-sorting.

Information of data sets in the test database before downloading or information stored in the storage server can be queried only through the authorized data set query module.

The mapping relation is a correspondence between complete information, especially annotation information and codes, of data sets in the test database stored in the storage server and viewable annotation information and codes of data sets used for performance testing, to ensure that testing personnel and the device to be tested can analyze the data sets while verifying accuracy of the data, thereby improving the fairness of the results of testing of the performance indicators including the FAR and the FRR of the device to be tested.

Further, the test database management method further includes: feeding back a test result and a data usage status during use, and uploading a data set for which anomaly occurs, to form a self-loop update mode for the test database.

Further, the data set identification rule is configured to perform hierarchical classification management according to different test databases and individual data sets in the different test databases, and assign different names, where identifiers are unique.

Further, the image coding rule is configured to form a dictionary table based on influencing factors of images according to a facial data set identifier superposition manner corresponding to a database, for automatic generation of codes which are unique.

The method effectively provides a test database for performance testing of facial recognition products through an information coding rule and a data set configuration and usage rule, to achieve security and traceability of data. The management system and the method of using same according to the invention can be used for the testing of facial recognition products and the improvement of product quality.

### BRIEF DESCRIPTION OF THE DRAWINGS

The invention will be further illustrated below in conjunction with the drawings and specific embodiments.

FIG. 1 is a schematic structural diagram of a test database management system according to an embodiment of the invention.

FIG. 2 is a schematic diagram of test database classification corresponding to a test database management system according to an embodiment of the invention.

FIG. 3 is a schematic diagram of life cycle state transition of a facial image according to an embodiment of the invention.

FIG. 4 is a schematic flowchart of a method of using a test database management system according to an embodiment of the invention.

FIG. 5 is a schematic flowchart of management and approval by a test database management system according to an embodiment of the invention.

FIG. 6 is a schematic diagram of a data set configuration rule according to an embodiment of the invention.

FIG. 7 is a schematic diagram of a data security mechanism according to an embodiment of the invention.

### DETAILED DESCRIPTION

To make the technical means, creative features, objects and effects of the invention easy to understand, the invention will be further described with reference to specific illustrations.

In view of the problems of existing solutions for testing the performance of facial recognition products, the invention provides a test database management solution for testing a facial recognition device.

In the test database management solution for testing a facial recognition device, the scale and diversity of test databases are improved based on performance influencing factors of facial recognition products in actual application scenarios, and the test databases are managed according to a security level management mechanism, with a strict approval process.

As an example, a data source target set involved in the test database management solution covers electronic photos in built-in chips of certificates such as resident identity cards, passports, and driver's licenses, acquired visual facial images of certificates, electronic photos of other certificates, and live facial images acquired on-site; covers actual application scenarios such as identity verification at public security checkpoints, entry and exit management, high-speed rail self-service customs clearance, airport self-service customs clearance, rail transit self-service customs clearance, community entrance and exit management, venue security management, bank counter business handling, social security real-name authentication, remote confirmation of identity verification, and hotel passenger identity verification; and covers influencing factors such as acquisition device, lighting environment, posture, age span, gender, facial expression, and skin color.

As an example, in a specific implementation of the test database management solution, by further referring to management mechanisms in GAIT 541-2011 “The data elements for public security” and GAIT 200.2 “Information codes for public security industry”, a whole life cycle state transition architecture of facial images or facial videos, a data security mechanism, a data set configuration rule, a data set identification rule and a facial image coding rule are innovatively given, so as to provide a conformance test database for facial recognition products in the process of testing performance indicators including the FAR and the FRR, thereby achieving security and traceability of data. In a subsequent solution of the embodiments of the invention, the test database required for testing comes from a test sub-database downloaded from a primary storage database of a storage server according to a ratio.

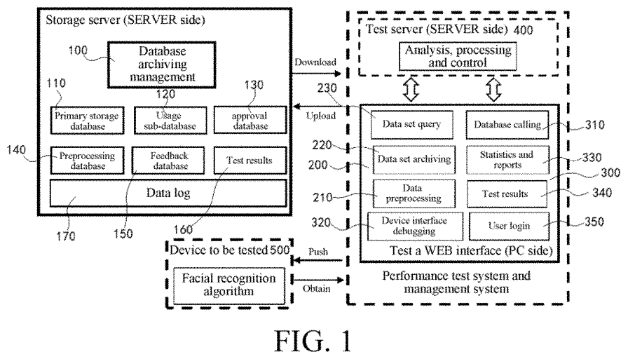

Referring to FIG. 1, an example structure of a test database management system for testing a facial recognition device that is formed based on the above test database management solution according to an embodiment of the invention is shown.

The test database management system is mainly composed of a database archiving management module 100, an evaluation annotation functional module 200 and a testing service functional module 300.

The database archiving management module 100 is configured to run in a storage server (SERVER side), periodically update data of a facial test database based on a usage management requirement, and perform hierarchical classification management based on user permission allocation and according to data set annotation information and a coding rule.

The database archiving management module 100 forms a data cycle through archive storage, secure download, configuration for use, and feedback update, and replaces, adds or deletes a facial image or facial video in an archived data set according to database rules and based on a usage management requirement.

Further, the database archiving management module manages different sub-databases in the facial test database according to user rights. For example, a super administrator has all rights, and approves and authorizes data updates to data sets in an approval database and a feedback database and corresponding data sets in the primary storage database, and configures and authorizes the use of usage sub-databases from the primary storage database. Different sub-databases corresponding to different user operation rights, to realize the whole life cycle state transition of data sets.

The evaluation annotation functional module 200 is configured to run in a client (e.g. in a test WEB interface (PC side)), exchange data with database archiving management module 100, automatically evaluate facial images and facial videos imported in large batches, perform data preprocessing and image annotation by a facial testing algorithm, and set a unique facial image code or a facial video code according to the data set identifier coding rule, to construct a large-scale normalized facial test database.

The testing service functional module 300 is configured to run in the client (e.g. in the test WEB interface (PC side)), call the database archiving management module to implement a testing service, effectively provide, for performance testing of a facial recognition product, especially an identity verification product, according to a data set configuration and usage rule, a test database that meets a standard, and provide a test result feedback statistics service, thereby achieving security and traceability of data.

Specifically, the testing service functional module 300 may obtain a usage sub-database with a set quantity and scale as a test database satisfying the standard according to the data set configuration and usage rule and based on a product performance testing requirement, so as to obtain a target set and a probe set that satisfy a specified sample distribution and quantity ratio. A test result obtained by performance testing is provided in the form of the feedback database for management by the database archiving management module to update the data of the primary storage database through feedback approval.

As an example, the database archiving management module 100 on the server side may perform download/upload exchange with a PC end operating the WEB interface through a test server (SERVER side) 400 of the performance test testing system, and perform push/obtain calling with a device to be tested 500 through a management system on the PC side, so as to provide a large-scale test database for the testing of the performance indicators including the FAR and the FRR.

The structures of the performance test testing system, the testing server (SERVER side) and the management system can be determined according to actual needs, which is not limited here.

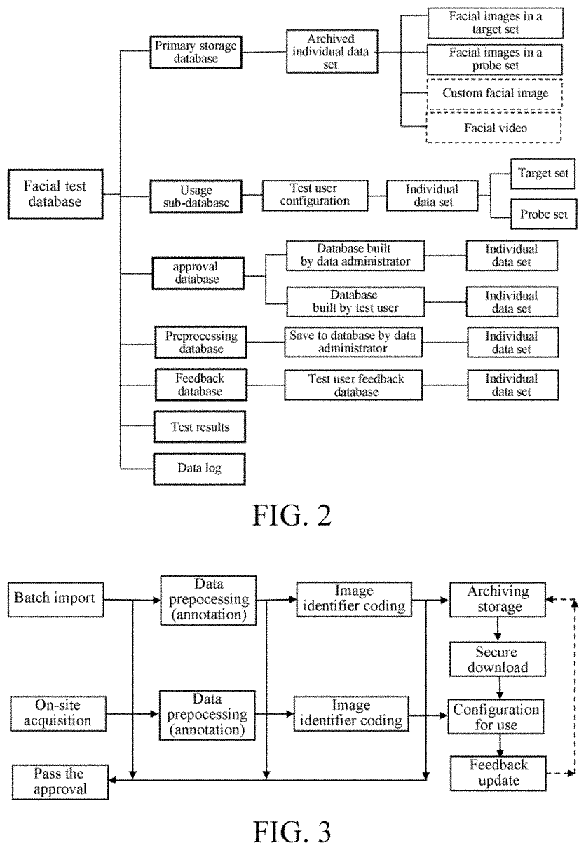

As shown in FIG. 1 and FIG. 2, in an embodiment, the database archiving management module 100 running on the storage server (SERVER side) performs hierarchical classification management based on a usage management requirement and user permission allocation and according to an identification and coding rule, and includes a primary storage database 110, a usage sub-database 120, an approval database 130, a preprocessing database 140, a feedback database 150, a test result database 160 and data logs 170.

The primary storage database 110 includes individual data sets of single individuals. That is, taking each individual as a unit, a set of all facial images and facial videos of an individual is a single individual data set. Data sets are summarized to form corresponding databases.

The primary storage database herein is a constructed target facial test database, that is, a summary database of standardized facial test databases with a scale of over one million. The facial images and facial videos in each individual data set have unique irreversible identification codes. The primary storage database is stored in the storage server for regular backup to prevent loss. Other sub-databases are built according to user rights and usage requirements, to realize the use and maintenance of the primary storage database.

As an example, each individual data set in the primary storage database includes: facial images such as identity card machine-readable photos, identity card electronic photos, passport electronic photos and the like specified in different standards or specifications or regulations in the target set; 1 to 10 facial images from actual application scenarios under different influencing factors in the probe set; custom facial images, individual videos and the like.

The usage sub-database 120 is generally a test database with a set scale and quantity obtained by a test user from the primary storage database according to a data set configuration rule and based on a performance test level requirement of a device to be tested, includes a target set and a probe set meeting a sample distribution requirement, and is configured to test performance indicators including the FAR and the FRR of the device to be tested.

The approval database 130 includes a database built by a data administrator and a database built by a test user, where an annotated data set in the built databases is verified according to an evaluation result from the evaluation annotation functional module, subjected to a conformity check performed based on a technical requirement on test databases in a standard, archived by the database archiving management module, and saved into the primary storage database after being approved by a user with highest rights.

The preprocessing database 140 is configured to receive facial images or facial videos initially imported into the storage server in batches, perform data preprocessing in cooperation with the evaluation annotation functional module, provide an evaluation result, generate an annotated data set, and save the annotated data set into the approval database.

The feedback database 150 includes individual data sets built by the test user, mainly coming from data sets for which a data anomaly occurs during performance testing performed by the testing service functional module using the downloaded usage sub-database, and is configured to update data in the primary storage database.

The test result database 160 is configured to store results of testing of the performance indicators including the FAR and the FRR for statistical analysis of test database service application requirements.

The data log 170 includes logs related to operations and audit of the above databases and test results.

In the database archiving management module 100 formed, the primary storage database is used as a finally stored facial test database, and permanent storage and backup are implemented in addition to periodic data updates. The usage sub-database is from the primary storage database and is configured to perform performance testing based on the data set configuration and usage rule. The approval database is converted from the preprocessing database after approval of an annotated data set formed by the evaluation and annotation functional module, and is archived into the primary storage database to expand the database scale after being approved. The feedback database comes from data sets for which a data anomaly occurs during performance testing, and is configured to update the data in the primary storage database after being verified by use.

Correspondingly, the evaluation annotation functional module 200 on the PC side runs in a client, exchanges data with database archiving management module, automatically evaluates facial images and facial videos imported in large batches, performs data preprocessing and image annotation by a facial testing algorithm and image processing, and sets a unique facial image code or a facial video code according to the data set identifier coding rule, to construct a large-scale normalized facial test database.

The evaluation annotation functional module 200 includes a data preprocessing module 210, a data set archiving module 220 and a data set query module 230.

In this system, the data preprocessing module 210 on the PC side performs face cutting and image quality evaluation prompting on facial images acquired on site or imported into the storage server in batches by using a method such as an image algorithm, face testing algorithm, optimal threshold image segmentation method and edge testing, and automatically transmits the preprocessed data and annotation information to the data set archiving module 220.

As an example, the data preprocessing module automatically processes facial images or facial videos imported into the storage server in batches. Objects to be processed is a facial image or facial video in a folder formed corresponding to each individual data set, and include a facial image sample of the target set and a facial image or facial video of the probe set. The data preprocessing module uses a face testing algorithm and an image algorithm to process the individual data set based on various factors such as a standard requirement corresponding to each photo specification, a technical requirement on the target set and the probe set in a standard of the identity verification device industry, and sample distribution of the test database. When a facial image or facial video appears after algorithm testing, abnormal data can be corrected by applying the optimal threshold image segmentation method, edge testing method, etc. For example, the machine-readable photo of identity card is a facial image sample in the target set, which meets the requirements of GA 490-2013 industry standard; If the photo does not meet the requirements, the photo is corrected and subjected to the algorithm testing again. If the photo still does not meet the requirements, a data anomaly is directly fed back, for later approval, addition and update. After data preprocessing, the individual data set is processed and the corresponding annotation information is obtained, and the data of the data set archiving module is provided for forming a unique identification code.

The data set archiving module 220 on the PC side is configured to annotate and generate codes for the preprocessed facial images according to an image identification and coding rule. As an example, it includes at least data set identifier, resolution, interpupillary distance, posture, adding pictures, deleting images, data types, generating image codes, and influencing factors such as facial expression and illumination. Uniqueness of data set identifiers and facial image codes may be managed by using a corresponding data set identification rule and an image coding rule according to different factors.

As an example, the annotation information of the facial image or facial video is automatically processed by the data preprocessing module using the face testing algorithm and an image processing algorithm. Correspondingly, the data set archiving module obtains the annotation information of the data preprocessing module and supports verification and modification, and automatically generates unique image or video codes according to the data set identification and coding rule. Facial images meeting the requirements of the target set and the probe set can be classified into the target set and the probe set in the individual data set. Facial video meeting the technical requirements of the probe set can be classified as the robe set in the individual data set. The data set archive module cooperates with the database archiving management module located in the storage server to archive and store the annotated data set.

As an example, the data set identification rule is configured to perform hierarchical classification management according to different test databases and individual data sets in the different test databases, and assign different names, where identifiers are unique, including the primary storage database, the usage sub-database, the approval database, the preprocessing database, the feedback database, the test result and respective individual data and names, as well as data log or other naming methods.

As an example, the data set identification and coding rule form a dictionary table based on influencing factors of images according to a facial data set identifier superposition mode corresponding to a database, for automatic generation of image codes or video codes which are unique, mainly including facial images corresponding to different certificate categories in the target set and facial images corresponding to different influencing factors in the probe set.

In an embodiment, the data set archiving module 220 automatically codes each facial image or each facial video by using the data set identification coding rule and verifies annotation information. For the data processed in batches, the data set is classified according to a facial test database construction requirement. The classification information is identified by a storage folder name and a data coding manner. Therefore, based on the unique code generated by the data set archiving module, the management system can accurately query the facial image or facial video in the individual data set, and manages and controls its whole life cycle state transition.

The data set query module 230 on the PC side in this system can query individual data sets in different test databases by using one or more screening conditions according to a rights requirement. The screening conditions include at least facial image parameters such as picture coding, integrity, gender, age distribution, nationality, skin color, twins, differences within 5 years, creation user and creation time. Combined with the analysis and statistics of the test database, the query result is displayed in units of individuals, including the integrity of individual data sets required for the target set and the probe set, the average scores required for influencing factors, the number of photos, gender, nationality, skin color, age distribution, creation time, etc., to provide a test database matching condition required for testing in an actual application scenario, and generate a statistical report according to the condition.

The object of the data set query module here is the individual data set in the primary storage database, that is, the facial test database stored in the storage server. The query result is the facial image or facial video in the individual data set, its annotation information, identification code and other data, and is used to provide data required by running of the data set configuration and usage rule and processing of the statistics and reports module. The data set query module can cooperate with the database archiving management module in the storage server to exchange data, and can directly query the annotated data set in the primary storage database according to rights; and can also cooperate with the data set archiving module 220 on the PC side to exchange data, and can directly query downloaded or to-be-uploaded annotated data sets stored in the PC side according to rights, for example, data sets of the test database, data sets of the approval database and data sets of the feedback database.

In this system, the testing service functional module 300 on the PC side calls the database archiving management module, effectively provides, for performance testing of a facial recognition product, especially an identity verification product, according to a data set configuration and usage rule, a test database that meets a standard, and provides a test result feedback statistics service, thereby achieving security and traceability of data.

As can be seen from the figure, the testing service functional module 300 in this system mainly includes a database calling module 310, a device interface debugging module 320, a statistics and reports module 330, a test result module 340 and a user login management module 350.

The database calling module 310 on the PC side interacts with the management system and the storage server, and is configured to download or upload an individual data set according to a requirement and an operation, including primary storage database configuration, usage sub-database download, approval database upload, preprocessing database upload, feedback database upload, test result upload and download, etc.

In this system, the device interface calling module 320 on the PC side interacts with the device to be tested 500 through the test interface function call, which is used for pushing or obtaining facial images, mainly obtaining facial images collected on site, pushing facial images in the test database, obtaining test results, etc.

The specific configuration of the device interface calling Module 320 can be determined according to actual requirements and will not be described here.

The statistics and reports module 330 on the PC side in this system is configured to provide data set statistics, project statistics, algorithm statistics and simulation test statistics.

As an example, the data set statistics are generated according to the distribution conditions such as gender, nationality and skin color. Project statistics are generated for the project according to conditions such as time periodicity, test times, test time consumption, usage distribution and test users as required. Algorithm statistics are generated for the algorithm evaluation results of the performance indicators including the FAR and the FRR according to conditions such as threshold, eigenvalue extraction success rate, FAR value or range, FRR value or range, OCR curve and so on as required.

The specific structure of this module can be determined according to actual requirements, and is not limited here.

The test result module 340 on the PC side is configured to manage test results of the performance indicators including the FAR and the FRR. The results include at least a photo for which feature value extraction fails, a relationship between a test sample photo in the test database and a feature comparison result, FAR limit value and corresponding similarity degree, FRR limit value and corresponding similarity degree and other information.

Further, the test result module provides data for which an anomaly occurs during the test process, for the database archiving management module to approve the data corresponding to the primary storage database and update processing. For example, a photo for which feature value extraction fails is one of abnormal data, the data corresponding to the primary storage database can be quired by the data set query module according to the picture code, and the database archiving management module, the data preprocessing module and the data set archiving module cooperate to revise and periodically update the individual data set. If the similarity is higher than the FAR or FRR limit, that is, the feature data of the target set and the feature data of the probe set in the test, the facial image of the target set, the facial image of the probe set or the facial video will be regarded as abnormal data in the test result, so as to implement the periodic update of the primary storage database.

In this system, the user login management module 350 on the PC side can cooperate with the database archiving management module to perform a rights-based access operation on each sub-database in the facial test database according to rights of a user. Generally, the browser web mode is used to access the storage server controlled based on database software to realize the man-machine interface interaction of the management system. The user mainly includes a super administrator, a data administrator and a test user.

As an example, the super administrator has highest rights, and only the super administrator can access the storage database and the approval of different state transitions of facial images in each database. The test administrator manages the test users, and has rights to manage the performance test system and access the management system. The test user performs a test operation on the PC side, including usage sub-database configuration and download, performance testing, data set database building, acquiring facial images on-site, data preprocessing, viewing test results, etc. The data administrator performs the construction of the large-scale test database, including batch import of facial images, data preprocessing, data set archiving, database building, etc.

The test database management system for testing a facial recognition device can be combined with the corresponding performance test system to test the performance of facial recognition products, Based on this test database management system, the user can easily import facial images in large batches, and automatically making judgment and assigning unique face information codes to the facial images according to a data set identification and a facial image coding rule, to build a test database of a required category. Therefore, the test database of the required scale can be downloaded according to the data set configuration and usage rule to form the target set and the probe set.

As an example, the data set configuration and usage rule here can be specified by the technical requirements on test databases in standards of identity verification devices in the public safety industry, and according to the annotation information and codes of the individual data sets, data in the test database required for testing performance indicators including the FAR and the FRR is formulated, and the formulated data is formed into a target set and a probe set in the individual data set, to provide objects to be called by an interface function in the performance test. One manner is to configure at least one facial image of the target set class and one facial image or facial video of the probe set class in individual data set. The number of facial images in the probe set is most preferably 10. Therefore, the ratio of these two types of data can be reflected in the annotation information of the individual data set as the completion degree and average score.

The dataset configuration and usage rule is started, the database calling module and the database archiving management module are called to configure data in the individual data set in the primary storage database according to the target set class specific to the data source and the probe set class with the characteristics of image influencing factors. By default, data of an individual of the target set class (target set) includes 50% identity card machine-readable photos, 30% passport electronic photos, 10% driver's license electronic photos, 5% certificate visible facial images and 3% other certificate electronic photos. Data of an individual of the probe set class (probe set) includes 1 to 10 facial images or a facial video covering the influencing factors such as acquisition device, illumination environment, posture, age span, gender, expression and skin color. According to the performance test level requirement of the FAR and the FRR, the scale and quantity of the test database are determined, that is, the number of non-repeated test personnel in the target set and the number of test facial images in the probe set are determined. The data set configuration rule maps the scale and quantity of the test database to the annotation information of the primary storage database, and the individual data set that meets the above requirement, that is, the usage sub-database, is selected. The usage sub-database and the on-site acquisition database are summarized by the database archiving management module in the performance test system at a ratio of 98%:2% to form test database for single-time performance test.

The system may further download a test database according to a data security mechanism during use, and implement data encryption and desensitization with reference to a mapping relationship for use.

The system may further feed back a test result and a data usage status during use, and upload a data set for which anomaly occurs, to form a self-loop update mode for the test database through the management system, thereby achieving continuous optimization and upgrade of the database.

As an example, as shown in FIG. 7, in an embodiment, the test database is a test sub-database formed according to the data set configuration and usage rule and based on a requirement of a single project test, is downloaded after authorization by a test administrator and stored in a ciphertext manner in a test server or test computer, and a data set information and code mapping table that simply sorts and numbers data after processing based on the mapping relationship can be viewed through a special decryption tool.

The test user views only desensitized information of data sets in the downloaded test database according to a condition after authorization by the data set query module of the management system, and by default, only browses images or plays videos. Sensitive information includes identifiers, codes, and annotation information of facial images or facial videos in data sets, sample distribution, etc.

A data set in the test database for which a data anomaly occurs during testing of the performance indicators including the FAR and the FRR is displayed in a form of a test result, only an image for which feature value extraction fails in the test result of the current test and a facial image or facial video in the test database are authorized through access and query of an automatic test system, and serial numbers of the image for which feature value extraction fails in the test result of the current test and the facial image or facial video in the test database are mapped to simple serial numbers obtained after local re-sorting.

Information of data sets in the test database before downloading or information stored in the storage server can be queried only through the authorized data set query module.

The mapping relation is a correspondence between complete information, especially annotation information and codes, of data sets in the test database stored in the storage server and viewable annotation information and codes of data sets used for performance testing, to ensure that testing personnel and the device to be tested can analyze the data sets while verifying accuracy of the data, thereby improving the fairness of the results of testing of the performance indicators including the FAR and the FRR of the device to be tested.

In a specific implementation, the test database management system for testing a facial recognition device can perform operations such as acquisition/batch import of the large-scale test database, preprocessing, image identification and coding, archiving storage, configuration for use, secure download and feedback update, etc., as well as the statistical analysis of project test results, and can be used to provide a test database required for testing the key performance indicators including the FAR and the FRR of facial recognition products, statistical report of project test results, etc.

It should be explained here that for the test data management system, the smallest unit is a facial image or a single facial image frame in a facial video. In view of management, the state of the whole life cycle of the facial image varies with the management level and usage process, and the state transition process is shown in FIG. 3.

Referring to FIG. 3, an example solution of life cycle state transition of a facial image according to an embodiment of the invention is shown.

The facial test database management system serves to provide a test database for testing the performance of a facial recognition product. The facial images or facial videos in the test database of the single test are from those imported in batches into the storage server and those collected by the product on-site. The obtained data can be used for performance testing only after preprocessing, annotation, coding, approval, archiving, downloading and other operations in various modules of the management system. After performance testing, the data in the primary storage database is updated periodically through abnormal data feedback, processing approval, and the like using modules such as the test result module, data set query module, and the data set archiving management module in the management system.

First, an approval database is prepared with data management rights. Initial facial images or facial images in a facial video (briefly referred to as “facial image”) are imported in batches into the preprocessing database stored in the storage server, processed by the data preprocessing module and the data set archiving module in the evaluation annotation functional module, and then archived to the primary storage database. The data preprocessing module uses a face testing algorithm, image cutting and other operations to process the facial images to obtain the corresponding annotation information. The facial image after processing carries annotation information, and is automatically identified by the data set archiving module to form a unique image identification code, and stored in the approval database. After being approved by the super administrator, the approval database is archived and stored in the primary storage database. The FAR and FRR performance testing is started, and the facial images stored in the primary database are configured according to the data set configuration rule, and stored in the usage sub-database. The usage sub-database is securely downloaded to the test server or the test computer (PC side) through the database calling module as a downloaded test database. The on-site acquisition test database is synchronously prepared. The approval database is prepared according to rights of the test user. The initial facial image is acquired on-site by the device to be tested, and includes the target set and the probe set.

The above data preprocessing and image identification and coding are repeated, and the downloaded test database and the on-site acquisition database are summarized at a ratio of 98%:2% to form the test database required for this performance test. After the FAR and FRR performance testing, abnormal data in the test process is stored in the test results, the corresponding facial images are cached into the feedback database, After approval, modification or replacement with new facial images, the corresponding facial images in the primary storage database can be queried according to picture codes, and feedback updates such as deleting, replacing new facial images and updating annotation information can be carried out, finally realizing periodic updates of facial images in the primary storage database, thus improving the data service quality of performance testing.

An implementation process where the test database management system for testing a facial recognition device in the embodiments provides a test database for testing the FAR and the FRR performance indicators of facial recognition products is described below.

As an example, a storage server (SERVER side), a test WEB interface (PC side), a test SERVER (SERVER side) and the like form a corresponding test environment.

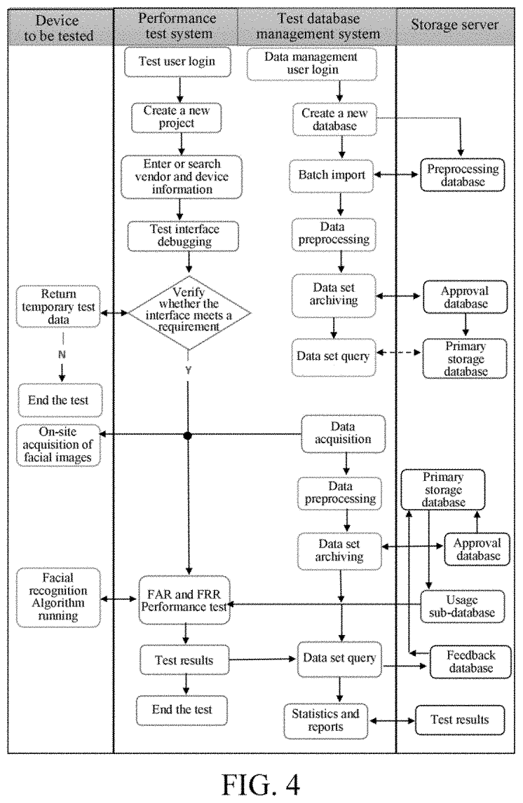

The facial test database archiving management module of the test database management system runs on the storage server (SERVER side), and operation modules such as data preprocessing, database calling, data set archiving, data set query, statistics and reports, user login management run on the test WEB interface (PC side). A corresponding implementation process is shown in FIG. 4, including following steps:
(1) Initialize the management system according to the user's operation in the test WEB interface.
(2) According to different objects to be managed, if the database is created by batch import mode, the user logs in to the management system by using rights of a data administrator, and perform step (3). If the database is created in an on-site acquisition mode and the FAR and the FRR performance testing is carried out, the user logs in to the performance testing system and the management system by using rights of a test user, and perform step (8).
(3) After logging in using rights of a data administrator, the user accesses the storage server to create a new folder according to an individual data set identifier of a preprocessing database, create a preprocessing database, and identify a folder name according to a preprocessing database identification rule.
(4) According to the classification of data sources, the individual data sets and all facial images therein are imported in batches on a per individual basis.
(5) Enter a “data preprocessing” interface, use a storage path corresponding to an individual data set identifier of the corresponding preprocessing database to preprocess the facial images in the individual data set, display a processing progress in real time in the form of progress bar, and display a processing result including a success rate of preprocessing and details of facial images for which the preprocessing fails. The number of facial images imported from individual data sets in each batch is controlled within 10,000, and batch import and FTP are supported.
(6) Enter a “Data Set Archiving” interface, and automatically generate data set identifiers and image codes in the approval database for the preprocessed facial image according to the data set identification and image coding rule. The interface automatically displays the archiving details of individual data sets by group, and supports visual manual modification and saving.

As an example, the details of image archiving in the data set can cover as many data influencing factors such as posture, resolution, interpupillary distance, data type, data source and application scenario as possible according to the face testing algorithm, image quality evaluation and cutting processing. By default, an optimal image is obtained by cutting according to a standard and stored.
(7) Enter a “Data Set Query” interface to query, based on user rights, the individual data sets or facial images stored in the approval database after archiving according to the individual data set identifier or image code. The facial images in the approval database are saved to the primary storage database after being approved by the super administrator according to the approval process. As an example, the super administrator can query the primary storage database.
(8) After logging in using rights of a test user, the user builds a new project, inputs vendor information and device information of the device to be tested, and uploads an algorithm configuration file and related technical data of the device. At the same time, historical records can be retrieved by vendor and device names, and project information can be automatically filled in.
(9) Start test interface debugging, select a dynamic link database and an algorithm configuration file of the device, and debug automatically according to a test interface function. The dynamic link database and algorithm configuration file here can be set according to actual needs, and are not limited here.
(10) Verify whether the interface of the device to be tested meets the test interface requirements specified in relevant industry standards and specifications such as Security protection—Face recognition applications—General technical requirements for identity verification equipment. If the device to be tested returns the temporary test data, step (11) is entered; otherwise, end the test.
(11) Before carrying out the performance indicator test, prepare to load the test database required for this performance test. First, a proportion of the usage sub-database is automatically according to the data configuration rule through the primary storage database, and the usage sub-database is downloaded to the test server or PC side according to a data security rule. Then an on-site acquired test database is prepared.
(12) Call the test interface to obtain the facial images acquired on-site from the device to be tested, repeat steps (3) to (7), obtain the individual data sets in the approval database, and form the on-site acquired test database.
(13) Summarize the downloaded and on-site acquired test databases and push same to the device to be tested to run the facial recognition algorithm to carry out the FAR and FRR performance testing.
(14) After the test is complete, test data is obtained by test interface debugging and uploaded to the storage server.
(15) Enter a “Data Set Query” interface. The data anomalies and the statistical analysis results of the test database, project and algorithm in the test process can be queried according to the mapping relationship after desensitization of the usage sub-database, and the statistical results and reports can be output.
(16) According to the data anomaly, after uploading, data is summarized and reported to the storage server for approval in the form of feedback database, so as to update the primary storage database and the usage sub-database.
(17) The test can be finished after confirming the test results. If the test results do not meet the requirements, step (8) can be repeated again.

On this basis, in a further implementation, the corresponding data set identification rule is configured to perform hierarchical classification management according to different test databases and individual data sets in the different test databases, and assign different names, where identifiers are unique, including the primary storage database, the usage sub-database, the approval database, the preprocessing database, the feedback database, the test result and respective individual data and names, as well as data log or other naming methods. Test databases are classified according to usage management requirements into a primary storage database, usage sub-database, approval database, preprocessing database, feedback database and data logs.

The hierarchical classification of test databases is realized in the management system based on this implementation, and the test databases need to be assigned different access permissions from the perspective of security. The super administrator has all access rights and sets rights management for users with different settings. Data administrators can have access to approval databases and preprocessing databases named after them. Test users can access database queries, download and creation, and feedback database upload processing. The data log is generated by an operation of each user, and each user can only access a file named by its own user name, at least including updated information such as the total data amount and classification details of each database.

As an example, the naming rules specifically include the following:
(4.1) The primary storage database can be accessed only by the super administrator. Generally, there is only one primary storage database and one backup database by default, and the backup database is stored in read1 of the storage server. The primary storage database is named “Identity Verification 0001+Creation Date”, for example, “RZHY000120200117”, that is, “Identity Verification 0001” primary storage database was created on Jan. 17, 2020.
(4.2) The usage sub-database is a test database with specified test level according to the sample classification type of the device to be tested and the usage habits of the test users, and is fixed after cyclic test. Naming parameters include sample type, test user name, test level, test quantity and data set distribution, etc. The photos of the target set and the test set are downloaded from the primary storage database according to the data ratio, and the individual photo code remains unchanged. Target set naming parameters include certificate type, photo number, data ratio and download time. Probe set naming parameters include the number of photos, the distribution of key parameters of photos and the download time. Same as above, the following format is used for naming: Chinese initials abbreviation+operation user initials abbreviation+serial number+creation time.
(4.3) The approval database is classified according to the system users, and can only be stored in the general database after approval, which is divided into data administrator database and test user database; Database building by a data administrator refers to the “data set archiving” interface on the PC side, and the data administrator operates the individual data set archived after the photo annotation processing. Database building by a test user refers to the individual data set acquired on site for the device corresponding to this task number in the process of algorithm test, which is imported into the usage sub-database according to the ratio of 2% specified in the standard as the test database downloaded to the PC side for this task. Same as above, the following format is used for naming: Chinese initials abbreviation+operation user initials abbreviation+serial number+creation time.
(4.3) The preprocessing database is imported by the data administrator, and copied to the individual data set to be preprocessed by the storage server according to the “data preprocessing” interface on the PC side. Same as above, the following format is used for naming: Chinese letter abbreviation+serial number+creation time; and the following format is used for naming: Chinese initials abbreviation+operation user initials abbreviation+serial number+creation time.
(4.4) The feedback database is a photo uploaded by the test user after the project test with the task number as the unit, and is named in the format of Chinese initials+operation users initials+serial number+creation time.
(4.5) The data log is a log file formed during the operation and management of the above-mentioned databases, and can be named after the above-mentioned databases.

Further, in the specific embodiment, the data set identification rule in step (6) sets naming parameters according to the type of test database sample distribution in the standard, including gender, age, skin color, difference, period, nationality, photo category and number, custom and 18-bit unique code. The photo category and number are specified as the total number of archived photos in the individual data set, the number of photos in the probe set and the number of photos in the target set. The 18-digit unique code defaults to the ID number. If it is a passport, Hong Kong, Macao and Taiwan, the prefix is filled with “0”. The following contents are specified:
(6.1.1) Beginning with JY, types are separated by an underscore “_”. Type=prefix=corresponding value
(6.1.2) The type cannot be passed, and if the type is not passed, the default value will be taken;
(6.1.3) JY_G Sex-N Ethnicity-R Skin Color-A Age Distribution-T Twins-D5 Year Difference-M Data Set Group Name, if labeled as: G male N Han R yellow under 16 years old_is twin_is 5 years difference_custom dataset name;
(6.1.4) Find the value corresponding to the type according to the table in Appendix 1, replace and generate the name: JY_00_01_00_00_01_01 Custom dataset name.

As an example, in this embodiment, the facial image coding rule in step (6) is shown in Appendix 2. The individual photo code includes the individual data set code and the photo code. The individual dataset code refers to the code in A3.1.2. According to the requirements of individual photos of target set and probe set specified in the standard, the naming parameters of single photos are set according to categories, The naming parameters of target set photos include certificate type, collection standard and creation date. The naming parameters of probe set photos include data source, actual application scenario, acquisition device, lighting environment, attitude, acquisition time and ornaments (with or without transparent glasses);

Custom photos and individual videos are not available for the time being. The following contents are specified:
(6.2.1) Beginning with ID, it is the target set picture; Does not start with ID, is a probe set picture;
(6.2.2) Types are separated by an underscore “_”. Type=prefix+corresponding value.
(6.2.3) The type cannot be passed, and if the type is not passed, the default value will be taken;
(6.2.4) Target set picture: ID_C Certificate Type_S Collection Standard_M Remarks; Such as ID_C passport_SGA 490-2013_M custom remarks; Corresponding name: ID_C03_S00_M Custom Notes
(6.2.5) Probe set picture: L Data Source_P Attitude_E Expression_G Illumination Environment_Y Application Scenario_B Acquisition device_T Acquisition Time_M Remarks; For example, PC acquisition_front_eyebrow rise_backlight_entry and exit management_scanner_2019-12-08 17:44:36_ custom remarks; Corresponding name: L00_P00_E03_G01_Y01_B02_T20191208174436 M custom comments.

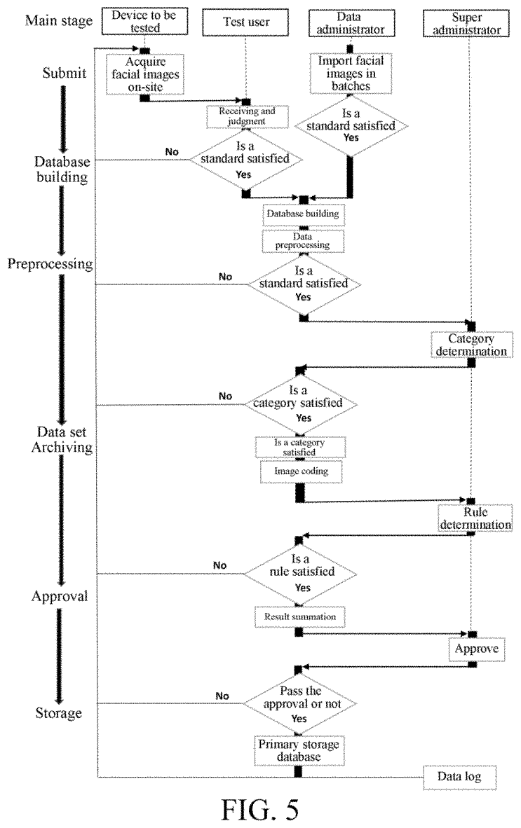

Further, in the specific implementation mode, the test database management system management approval process in the step (7) carries out safety management on the storage master base with the highest management rights, and transfers the submitted approval base to the storage master base after being approved, as shown in FIG. 5. In terms of user rights of the management system, the approval process involves personnel including a super administrator, a data administrator and a test user. As an example, the following specific steps are carried out according to different main stages:
(7.1) Submission stage: The facial image collected on site is provided from the device to be tested through the test interface, and the test user receives and judges that it meets the standard requirements, and then enters the database construction stage; On the other hand, the data administrator imports facial images in batches and judges whether they meet the standard requirements, and then enters the database construction stage; The approval process of the latter two types of users is similar;
(7.2) Database construction stage: The user judges whether the face testing algorithm, image clipping and quality in data preprocessing meet the standard requirements and submits them to the super administrator;
(7.3) Data set archiving stage: Naming different databases according to the classification of test databases, identifying individual data sets and coding facial images, forming an approval database and submitting it to a super administrator;
(7.4) approval stage: According to the data set identification and image coding rules, the approval results are comprehensively evaluated and approved according to the requirements in Appendix 1 and Appendix 2, and transferred to the primary storage database;
(7.5) All the different steps in the approval process are stored in the data log. Further, in this embodiment, the data configuration rule in step (11) is used to provide a test database satisfying the test sample distribution requirements, which is automatically formed according to different types of facial images in a specific matching ratio.

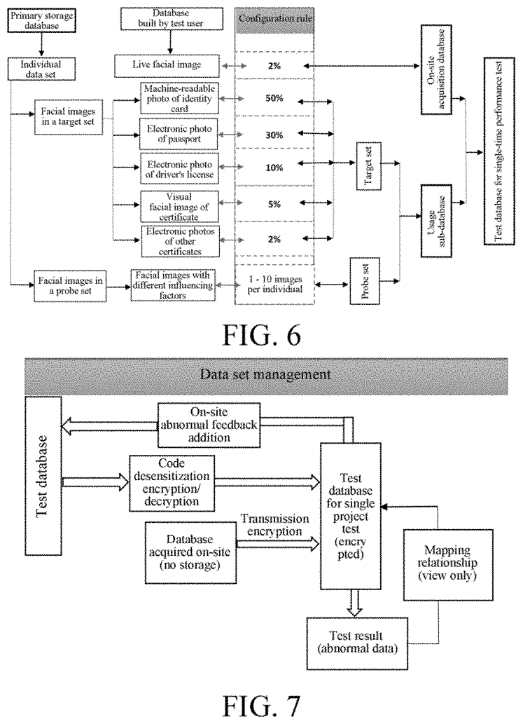

As an example, FIG. 6 shows an example solution of data set configuration rules, which requires the following:
(11.1) The facial image sample of the target set consists of electronic photos from the built-in chips of resident identity cards, passports, driver's licenses and other certificates or collected visual facial images of certificates, electronic photos of other certificates and live facial images collected on the spot;
(11.2) Machine-readable photos of identity cards: meet the relevant requirements of GA 490-2013, accounting for 50%;
(11.3) Passport electronic photo: Meet the relevant requirements of GA/T 1180-2014, accounting for 30%;
(11.4) Electronic photo of driver's license: Meet the relevant requirements of GA 482-2008, accounting for 10%;
(11.5) Visual facial image of certificate: Meet the relevant requirements of 5.3 in GA/T 1324-2017 and Appendix B in the standard, accounting for 5%;
(11.6) Electronic photos of other certificates: Meet the relevant requirements in Appendix A of the standard, accounting for 3%;
(11.7) Live facial images: The living facial images collected by the tested device are imported and registered, and the image quality meets the relevant requirements of 4.2 in GB/T 35678-2017, accounting for 2%.
(11.8) The facial images in the testing concentration come from actual application scenarios such as identity verification at public security checkpoints, entry and exit management, high-speed rail self-service customs clearance, airport self-service customs clearance, rail transit self-service customs clearance, community entrance and exit management, venue security management, bank counter business handling, social security real-name authentication, remote confirmation of identity verification, and hotel passenger identity verification;
(11.9) The facial images in the probe set cover the influencing factors such as acquisition device, lighting environment, posture, age span, gender, expression and skin color;
(11.10) Each facial image in the probe set has and only has a unique face; (11.11) The number of facial images of the same target person in the face probe set is 1 ˜10;
(11.12) Multiple images of the same person have at least one difference in lighting environment, posture, ornaments, expression, acquisition time and acquisition device;
(11.13) There are facial images in the probe set with the same identity as all facial images in the target set;
(11.14) The facial image quality meets the requirements of 4.2 in GB/T 35678-2017.
(11.15) The size of the test database shall meet the following requirements: Basic requirement: N≥2000, M≥20000; Enhanced requirement N≥10000, M≥100000.

Note: Where N is the number of non-repeated testers in the target set, and M is the number of test facial images in the probe set.
(11.16) Test database sample distribution shall meet the following requirements:
   (A) Sex distribution: Male and female accounted for (50±5)% respectively.
   B) Age distribution: (15±3)% were under 16 years old, (75±5)% were between 16 and 60 years old, and (10±3)% were over 60 years old.
   C) Distribution of differences: Avoid very similar people such as twins;
   D) Time span distribution: Avoid warehousing documents and photos with no obvious changes in facial features of the same tester within five years at the same time;
   (e) Ethnic distribution: Chinese Han people account for (60±5)%, Chinese ethnic minorities with obvious differences in facial features from Han people account for (20 5)%, white people account for (5±2)%, black people account for (5±2)%, brown people account for (5±2)%, and yellow people from other Asian countries account for (5±2)%.

Further, In the specific embodiment, the data security mechanism in the step (15) is used for controlling the facial recognition related data of the whole system in combination with the performance test system and the device to be tested according to the information security requirements.

As an example, FIG. 7 shows an example solution of a data security mechanism. As can be seen from the figure, in the test process, the test database is downloaded from the test database coding desensitization and encryption/decryption processing to a single project test, and encrypted and stored; At the same time, the database collected on site, which is not stored in the device to be tested, is directly acquired as a part of the test database converted into a single project test, and the data test is loaded. If there is any abnormal data after the test, the data set can be viewed by mapping relationship, so that the facial image code of the primary storage database can be hidden and protected. After the anomaly is confirmed, it is fed back to the storage server according to the user's rights to optimize and upgrade the primary storage database, so as to realize the self-circular update of the whole life cycle state transition of facial images.

It can be seen from the above that the solution in this embodiment effectively provides a test database that satisfies a standard for performance testing of facial recognition products, especially identity verification products, through an information coding rule and a data set configuration rule, to achieve security and traceability of data.

Furthermore, when the solution of this example is implemented, It can not only serve the testing of facial recognition products and improve product quality, Combined with the test results, it can also provide real and effective data support for different types of facial recognition products to be applied in different actual application scenarios such as identity verification at public security checkpoints, entry and exit management, high-speed rail self-service customs clearance, airport self-service customs clearance, rail transit self-service customs clearance, and community entrance and exit management.

The method of the invention, or specific system units, or parts thereof are of a pure software architecture, and can be deployed on a physical medium, such as a hard disk, optical disc, or any electronic device (such as a smart phone or computer-readable storage medium) in the form of program code. When a machine (such as a smart phone) loads and executes the program code, the machine becomes an apparatus that implements the invention. The method and apparatus of the invention can also be transmitted in the form of program code through some transmission media, such as cable, optical fiber, or any transmission mode. When the program code is received, loaded and executed by a machine (such as a smart phone), the machine becomes an apparatus that implements the invention.

The basic principles, main features and advantages of the invention have been shown and described above. Those skilled in the art should understand that the invention is not limited to the above-mentioned embodiments. The descriptions of the embodiments and the specification are only for illustrating the principles of the invention. Various changes and improvements may be made to the invention without departing from the spirit and scope of the invention. and such changes and improvements all fall within the scope of protection claimed by the invention. The scope of protection claimed by the invention is defined by the appended claims and their equivalents.

What is claimed is:

1. A facial test database management system for testing a facial recognition device, comprising a database archiving management module, an evaluation annotation functional module, and a testing service functional module, wherein
the database archiving management module is configured to run in a storage server, periodically update data of a facial test database based on a usage management requirement, and perform hierarchical classification management based on user permission allocation and according to data set annotation information and a data set identifier coding rule;
the evaluation annotation functional module is configured to run in a client, exchange data with database archiving management module, automatically evaluate facial images and facial videos imported in large batches, perform data preprocessing and image annotation by a facial testing algorithm and image processing, and set a unique facial image code or a facial video code according to the data set identifier coding rule, to construct a large-scale normalized facial test database; and
the testing service functional module is configured to run in the client, call the database archiving management module, provide, for performance testing of a facial recognition product according to a data set configuration and usage rule, a test database that meets a standard requirement, and provide a test result feedback statistics service.

2. The facial test database management system according to claim 1, wherein the database archiving management module comprises a primary storage database, a usage sub-database, an approval database, a preprocessing database and a feedback database;
the primary storage database comprises individual data sets of single individuals, and a facial image and facial video in each individual data set in a constructed target facial test database each have a unique irreversible identification code;
the usage sub-database is a test database with a set scale and quantity obtained from the primary storage database according to a data set configuration rule and based on a performance test level requirement of a device to be tested, comprises a target set and a probe set meeting a sample distribution requirement, and is configured to test performance indicators comprising a Fault Acceptance Rate (FAR) and a Fault Rejection Rate (FRR) of the device to be tested;
the approval database comprises a database built by a data administrator and a database built by a test user, wherein an annotated data set in the built databases is verified according to an evaluation result from the evaluation annotation functional module, subjected to a conformity check performed based on a technical requirement on test databases in a standard, archived by the database archiving management module, and saved into the primary storage database after being approved by a user with highest rights;
the preprocessing database is configured to receive facial images or facial videos initially imported into the storage server in batches, perform data preprocessing in cooperation with the evaluation annotation functional module, provide an evaluation result, generate an annotated data set, and save the annotated data set into the approval database; and
the feedback database comprises individual data sets built by the test user, mainly coming from data sets for which a data anomaly occurs during performance testing performed by the testing service functional module using the downloaded usage sub-database, and is configured to update data in the primary storage database.

3. The facial test database management system according to claim 2, wherein the database archiving management module further comprises a test result database and/or data logs, and the test result database is configured to store results of testing of the performance indicators comprising the FAR and the FRR for data update association and statistical analysis of test database service application requirements; and the data logs comprise logs related to operations and audit of all databases and test results in the database archiving management module for facial testing.

4. The facial test database management system according to claim 1, wherein the evaluation annotation functional module comprises a data preprocessing module, a data set archiving module and a data set query module;
the data preprocessing module is configured to perform face cutting and image quality evaluation prompting on facial images acquired on site or imported in batches through corresponding image processing methods, and automatically transmitting the preprocessed data to the data set archiving module;
the data set archiving module is configured to annotate and generate codes for the preprocessed facial images according to an image identification and coding rule; and manage uniqueness of data set identifiers and facial image codes by using a corresponding data set identification rule and/or facial image coding rule according to different facial information factors; and
the data set query module is configured to query individual data sets in different test databases by using one or more screening conditions according to a rights requirement, provide a test database matching condition required for testing in an actual application scenario, and generate a statistical report according to the condition.

5. The facial test database management system according to claim 1, wherein the testing service functional module comprises a database calling module, a device interface debugging module, a statistics and report module and a test result module;
the database calling module is configured to download or upload an individual data set according to a requirement and an operation;
the device interface debugging module is configured to interact with the device to be tested by calling a test interface function, to push or obtain a facial image;
the statistics and reports module is configured to provide data set statistics, project statistics, algorithm statistics and simulation test statistics; and
the test result module is configured to manage test results of the performance indicators comprising the FAR and the FRR.

6. The facial test database management system according to claim 5, wherein the testing service functional module further comprises a user login module, and the user login module is configured to cooperate with the database archiving management module to perform a rights-based access operation on each sub-database in the facial test database according to rights of a user.

7. A test database management method for testing a facial recognition device, comprising:
importing facial images in large batches, and automatically making judgment and assigning unique face information codes to the facial images according to a data set identification and coding rule, to build a test database of a required category; and
downloading a test database of a required scale according to a data set configuration and usage rule to form a target set and a probe set.

8. The test database management method according to claim 7, wherein the test database management method further comprises: downloading a test database according to a data security mechanism during use, and implementing data encryption and desensitization with reference to a mapping relationship for use.

9. The test database management method according to claim 7 or 8, wherein the test database is a test sub-database formed according to the data set configuration and usage rule and based on a requirement of a single project test, is downloaded after authorization and stored in a ciphertext manner, and a data set information and code mapping table that simply sorts and numbers data after processing based on the mapping relationship can be viewed through a special decryption tool.

10. The test database management method according to claim 7 or 8, wherein a data set in the test database for which a data anomaly occurs during performance indicator testing is displayed in a form of a test result, only an image for which feature value extraction fails in the test result of the current test and a facial image or facial video in the test database are authorized through access and query of an automatic test system, and serial numbers of the image for which feature value extraction fails in the test result of the current test and the facial image or facial video in the test database are mapped to simple serial numbers obtained after local re-sorting.

11. The test database management method according to claim 8, wherein the mapping relation is a correspondence between complete information, especially annotation information and codes, of data sets in the test database stored in the storage server and viewable annotation information and codes of data sets used for performance testing.

12. The test database management method according to claim 7, wherein the test database management method further comprises: feeding back a test result and a data usage status during use, and uploading a data set for which anomaly occurs, to form a self-loop update mode for the test database.

13. The test database management method according to claim 7, wherein the data set identification rule is configured to perform hierarchical classification management according to different test databases and individual data sets in the different test databases, and assign different names, where identifiers are unique.

14. The test database management method according to claim 7, wherein the image coding rule is configured to form a dictionary table based on influencing factors of images according to a facial data set identifier superposition manner corresponding to a database, for automatic generation of codes which are unique.
